(19) United States
(12) Patent Application Publication
(10) Pub. No.: US 2012/0301014 A1
(43) Pub. Date: Nov. 29, 2012

(54) LEARNING TO RANK LOCAL INTEREST POINTS

(75) Inventors: Rong Xiao, Beijing (CN); Rui Cai, Beijing (CN); Zhiwei Li, Beijing (CN); Lei Zhang, Beijing (CN)

(73) Assignee: Microsoft Corporation, Redmond, WA (US)

(21) Appl. No.: 13/118,282

(22) Filed: May 27, 2011

(51) Int. Cl. G06K 9/62; G06K 9/46

(52) U.S. Cl. 382/159; 382/195

(57) ABSTRACT

Tools and techniques for learning to rank local interest points from images using a data-driven scale-invariant feature transform (SIFT) approach termed “Rank-SIFT” are described herein. Rank-SIFT provides a flexible framework to select stable local interest points using supervised learning. A Rank-SIFT application detects interest points, learns differential features, and implements ranking model training in the Gaussian scale space (GSS). In various implementations a stability score is calculated for ranking the local interest points by extracting features from the GSS and characterizing the local interest points based on the features being extracted from the GSS across images containing the same visual objects.

### BACKGROUND

Research efforts related to local interest points are in two categories: detector and descriptor. Detector locates an interest point in an image; while descriptor designs features to characterize a detected interest point. Conventional scale-invariant feature transform (SIFT) describes a computer vision technique to detect and describe local features in images. However, typically conventional SIFT only provides some basic mechanisms for local interest point detection and description.

The conventional SIFT algorithm consists of three stages: 1) scale-space extremum detection in difference of Gaussian (DoG) spaces; 2) interest point filtering and localization; and 3) orientation assignment and descriptor generation. Traditionally focus is placed on the third stage, designing better features to reduce dimensionality or improving the descriptive power of the descriptor for a local interest point such as using principal components of gradient patches to construct local descriptors, extracting colored local invariant feature descriptors, or using a discriminative learning method to optimize local descriptors under semantic constraints.

In conventional SIFT, existing methods to reject unstable local extremum use handcrafted rules for discarding low-contrast points and eliminating edge responses.

The conventional SIFT algorithm has three unavoidable drawbacks: 1) The SIFT algorithm is sensitive to thresholds. Small changes in the thresholds produce vastly different numbers of local interest points on the same image. 2) Manually tuning the thresholds to make the detection results robust to varied imaging conditions is not effective. For example, thresholds that work well for compression may fail under image blurring. 3) Moreover, in the filtering step, conventional SIFT is limited to considering the differential features of local gradient vector and hessian matrix in the DoG scale space.

FIG. 1 illustrates four examples of conventional SIFT output using handcrafted parameters for an image 100. For illustration, the top 25 interest points are shown on image 100(1), 50 on image 100(2), 75 on image 100(3), and 100 on image 100(4). A “+” is used to designate an identified interest point. Note that for each image several, and an increasing number, of interest points are detected away from the building, which is the focus of the images.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

According to some implementations, techniques referred to herein as “Rank-SIFT” employ a data-driven approach to learn a ranking function to sort local interest points according to their stabilities across images containing the same visual objects using a set of differential features. Compared with the handcrafted rule-based method used by the conventional SIFT algorithm, Rank-SIFT substantially improves the stability of detected local interest points.

Further, in some implementations, Rank-SIFT provides a flexible framework to select stable local interest points using supervised learning. Example embodiments include designing a set of differential features to describe local extremum points, collecting training samples, which are local interest points with good stabilities across images having the same visual objects, and treating the learning process as a ranking problem instead of using a binary (“good” v. “bad”) point classification. Accordingly, there are no absolutely “good” or “bad” points in Rank-SIFT. Rather, each point is determined to be relatively better or worse than another. Ranking is used to control the number of interest points on an image, according to requirements for a particular application to balance performance and efficiency.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a set of four example images showing conventional SIFT output.

FIG. 2 is a block diagram of an example framework for offline training ranking local interest points to improve local interest point detection according to some implementations.

FIG. 3 is a block diagram of an example framework for online local interest point ranking using Rank-SIFT according to some implementations.

FIG. 4 illustrates an example architecture including a hardware and logical configuration of a computing device for learning to rank local interest points using Rank-SIFT according to some implementations.

FIG. 5 is a block diagram of example applications employing Rank-SIFT according to some implementations.

FIG. 6 is a set of four example images showing Rank-SIFT output according to some implementations.

FIG. 7 is a group of six images showing repeatability using Rank-SIFT according to some implementations.

FIG. 8 is a chart comparing an example of conventional SIFT with Rank-SIFT using different set of features in some implementations.

FIG. 9 is a flow diagram of an example process for determining a stability score for training according to some implementations.

FIG. 10 is a flow diagram of an example process for calculating a stability score for a local interest point from a group of images with the same visual object according to some implementations.

FIG. 11 is a flow diagram of an example process for calculating a ranking score using the model learned from offline training according to some implementations.

### DETAILED DESCRIPTION

### Overview

This disclosure is directed to a parameter-free scalable framework using what is referred to herein as a “Rank-SIFT” technique to learn to rank local interest points. The described operations facilitate automated feature extraction using interest point detection and differential feature learning. For example, the described operations facilitate automatic identification of extremum local interest points that describe informative and distinctive content in an image. The identified interest points are stable under both local and global perturbations such as view, rotation, illumination, blur, and compression.

A local interest point (together with the small image patch around it) is expected to describe informative and distinctive content in the image, and is stable under rotation, scale, illumination, local geometric distortion, and photometric variations. A local interest point has the advantages of efficiency, robustness, and the ability of working without initialization. In addition, local interest points have been widely utilized in many computer vision applications such as object retrieval, object categorization, panoramic stitching and structure from motion.

The number of DoG extremum points output by the first stage conventional SIFT is often thousands for each image, many of which are unstable and noisy. Accordingly, the second stage of conventional SIFT, selecting robust local interest points from those scale-space extremum is important, because having too many interest points on an image significantly increases the computational cost of subsequent processing, e.g., by enlarging the index size for object retrieval, object category recognition, or other computer vision applications.

Often important features that are meaningful for humans are missed when using conventional SIFT detection. In addition, conventional SIFT results often include an unworkable number of random noise points due to non-robust heuristic steps being leveraged to remove ambient noise. Another drawback of conventional SIFT is rule-based filtering including some thresholds that must be manually fine tuned for each image.

Conventional SIFT includes three steps. The first step includes constructing a Gaussian pyramid, calculating the DoG, and extracting candidate points by scanning local extremum in a series of DoG images. The second step includes localizing candidate points to sub-pixel accuracy and eliminating unstable points due to low contrast or strong edge response. The third step includes identifying dominant orientation for each remaining point and generating a corresponding description based on the image gradients in the local neighborhood of each remaining point. In the second step, a typical scale-space function D(x, y, σ) can be approximated by using a second order Taylor expansion, which is shown in Equation 1.

$$D ( x + δ x ) = D + \frac{d {D}^{T}}{d x} δ x + \frac{1}{2} δ {x}^{T} \frac{{\partial }^{2} {D}^{T}}{\partial {x}^{2 }} δ x \qquad ( 1 )$$

In Equation 1, x=(x, y, σ)^{T} denotes a point whose coordinate is (x, y) and the scale factor is σ. Meanwhile, as shown in Equation 2, the local extremum is determined by setting ∂D(x+δx)/∂(δx)=0.

$$δ \hat{x} = \frac{{\partial }^{2} {D}^{- 1}}{\partial {x}^{2 }} \frac{\partial D}{\partial x} \qquad ( 2 )$$

The function value at the extremum, D(\hat{x})=D(x+δ\hat{x}), can be obtained by substituting Equation (2) into Equation (1), to obtain Equation 3.

$$D ( \hat{x} ) = D + \frac{1}{2} \frac{\partial D}{\partial x} δ \hat{x} \qquad ( 3 )$$

Traditionally, extremum points with low DoG value are rejected due to low contrast and instability. Conventional SIFT adopts a threshold γ₁=0.03 (image pixel values in the range [0,1]) to reject extremum points {∀\hat{x}, |D(\hat{x})|<γ₁}.

The typical DoG operator has a strong response along edges. However, many of the edge response points are unstable due to having a large principal curvature across the edge with a small perpendicular principal curvature. Conventional SIFT uses a Hessian matrix H to remove such misleading extremum points. The eigenvalues of a Hessian matrix H can be used to estimate the principal curvatures as shown in Equation 4.

$$H = [ \begin{matrix}{D}_{xx} & {D}_{xy} \\ {D}_{xy} & {D}_{yy}\end{matrix} ] \qquad ( 4 )$$

To insure the ratio of principal curvatures is below some threshold γ₂, those points satisfying Equation 5 are rejected when the ratio between the largest magnitude eigenvalue and the smaller one is γ₂≧1, since the quantity (γ₂+1)²/γ₂ is monotonically increasing when γ₂≧1.

$$\frac{{Tr ( H )}^{2}}{Det ( H )} \geq \frac{{( {γ}_{2} + 1 )}^{2}}{{γ}_{2}} \qquad ( 5 )$$

Equations (3) and (5) demonstrate that the conventional SIFT algorithm uses two thresholds in the DoG scale space to filter local interest points.

Experimental results of an example implementation of Rank-SIFT on three benchmark databases in which images were generated under different imaging conditions show that Rank-SIFT substantially improves the stability of detected local interest points as well as the performance for computer vision applications including, for example, object image retrieval and category recognition. Surprisingly, the experimental results also show that the differential features extracted from Gaussian scale space perform better than the DoG scale space features adopted in conventional SIFT. Moreover, the Rank-SIFT framework is flexible and can be extended to other interest point detectors such as a Harris-affine detector, for example.

In Rank-SIFT, local interest points are detected for efficiency, robustness, and workability without initialization. Various embodiments in which automated identification of local interest points is useful include implementations for computer vision applications such as object retrieval, object recognition, object categorization, panoramic image stitching, robotic mapping, robotic navigation, 3-D modeling, and determining structure from an object in motion including gesture recognition, video tracking, etc.

The discussion below begins with a section entitled “Example Framework,” which describes one non-limiting environment that may implement the described techniques. Next, a section entitled “Example Applications” presents several examples of applications using output from learning to rank local interest points using Rank-SIFT. A third section, entitled “Example Processes” presents several example processes for learning to rank local interest points using Rank-SIFT. A brief conclusion ends the discussion.

This brief introduction, including section titles and corresponding summaries, is provided for the reader's convenience and is not intended to limit the scope of the claims, nor the proceeding sections.

### Example Framework

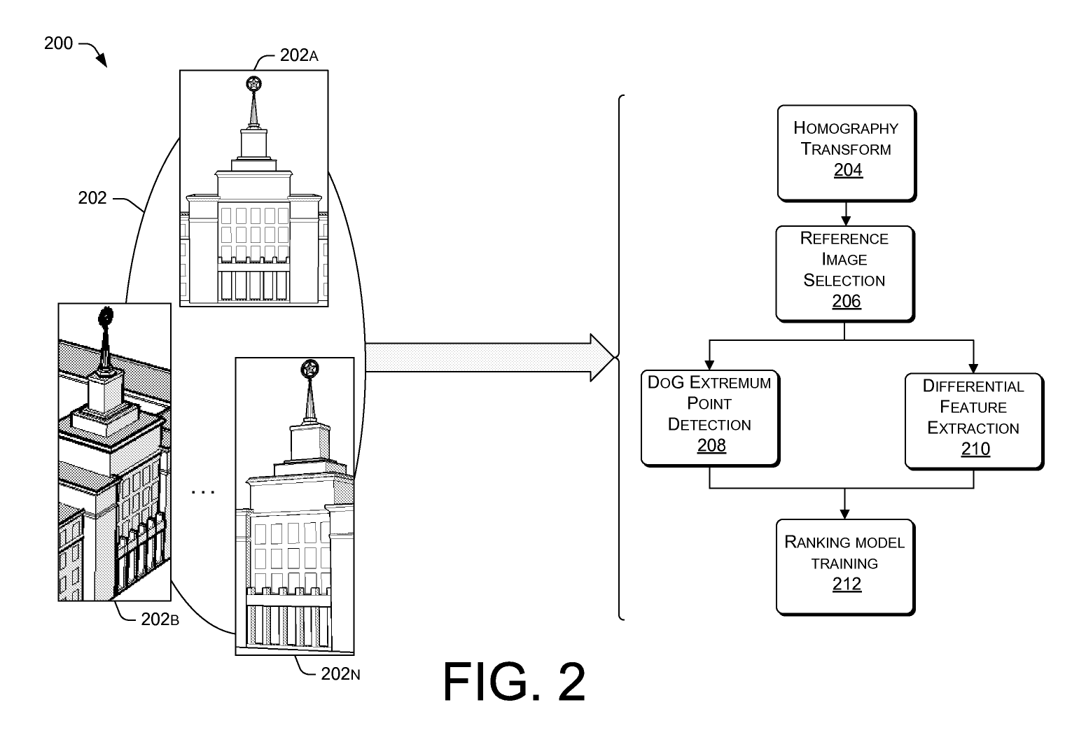

FIG. 2 is a block diagram of an example offline framework 200 for training a ranking model according to some implementations. FIG. 2 illustrates learning stability of interest points from a group of images 202. The group of images 202 includes multiple images of the same visual object or scene from different perspectives, rotation, elevation, etc. and different illumination, magnification, etc. For example, image 202a illustrates a building from one perspective in good illumination while image 202b illustrates the same building from another perspective with lower illumination. Any number of images may be included in the group of images up to an image 202n, which is an image of the same building from yet another perspective, with good illumination.

A homography transformation component 204 aligns the images to build a matrix of DoG extremum points from the group of images 202. Homography transformation is used to build point correspondence between two images of the same visual object or scene. The homography transformation component 204 maps one point in one image to a corresponding point in another image that has the same physical meaning. DoG extremum points are identified as special points detected in an image which are relatively stable. In various implementations a DoG extremum point's corresponding point (using homography transformation) in another image may not be a DoG extremum point in the other image. The word “stable” as used herein means that for a DoG extremum point in one image the DoG extremum point's corresponding point (using homography transformation) in another image has a greater likelihood, that is a likelihood above a predetermined or configurable likelihood threshold, to be a DoG extremum point. The homography transformation component 204 accounts for the transformation between the different images to map the same DoG extremum point as illustrated in the second image. In addition, the homography transformation component 204 calculates a position of a DoG extremum point determined to be the same DoG extremum point represented in another image.

In various implementations a reference image selection component 206 randomly selects a reference image from the group of images, although other criteria for selection are possible. For example, a reference image selection component 206 may select a reference image for the group of images based on the particular group of images 202 and the matrix produced by homography transformation component 204. For various groups of images, the number of DoG extremum points detected will vary and may number in the thousands.

A DoG extremum point detection component 208 identifies stable local points from a sequence or group of images describing the same visual object or scene. The DoG extremum point detection component 208 detects DoG extremum points in the reference image and for each DoG extremum point, calculates a stability score. In at least one implementation, the homography transformation component 204 is used to find corresponding points (having the same physical meaning) in another image from the group of images 202. Because the DoG extremum point is stable, the point in the other image corresponding to the DoG extremum point has a greater likelihood of being a DoG extremum point in the other image. For a group of images, e.g., six images, nine images, twelve images, etc., the DoG extremum points are extracted. One of the group of images is selected as the reference image. For each DoG extremum point in the reference image, the homography transformation component 204 finds corresponding points in the other images using homography transformation. For example, in a group of six images, the homography transformation component 204 finds five corresponding points in the five images other than the reference image—one in each of the other images. The DoG extremum point detection component 208 defines the stability score as the number of DoG extremum points found in these five corresponding points.

DoG extremum points may be stable but with a lower stability score when the corresponding point is not identified as a DoG extremum point in each image. In various implementations, a DoG extremum point is found in the reference image and the homography transformation component 204 is used to find a position of a corresponding point, having the same physical meaning, in the second image. Because the DoG extremum point in the reference image is stable, the corresponding point in the second image has a greater likelihood of being a DoG extremum point for the second image. While the homography transformation may not identify exactly the position of the corresponding point in the second image, when a corresponding point is within a threshold distance near the position calculated by the homography transformation, it means that the DoG extremum point is relatively stable. A stability score is determined by from the number of DoG extremum points found in the corresponding points of the other images of the group 202.

Sometimes there are DoG extremum points in the images of the group 202 that are identified near the expected position of the DoG extremum point from the reference image by homography transformation. Sometimes the DoG extremum point from the reference image does not have a corresponding position in each of the images, but only in some of the images from the group 202. The less corresponding DoG extremum points in the remaining images to the DoG extremum point from the reference image, the less stable the DoG extremum point is determined to be. For example, a DoG extremum point identified in the reference image, but for which no corresponding DoG extremum points are located in the remaining images using homography transformation, is not determined to be stable.

The stability score is a count of how many DoG extremum points are identified in the remaining images of the group of images 202 corresponding to the DoG extremum point identified in the reference image. When a corresponding DoG extremum point is identified in each image, that DoG extremum point is most stable and assigned a score of the number of remaining images in the group 202. For example, for a group of nine images, when the corresponding DoG extremum point is identified in each image the stability score of the DoG extremum point is 8. However, if no corresponding DoG extremum point is identified in the other images, then is the DoG extremum point is determined to not be stable and would have a stability score of 0. For DoG extremum points that have corresponding DoG extremum points in some, but not all of the images of the group, the stability score will reflect the number of images that contain a corresponding DoG extremum point. For example, when a corresponding DoG extremum point is found in five images, the stability score is 5. In various implementations, groups of the same number of images can be compared.

A differential feature extraction component 210 employs a supervised learning model to learn differential features. For example, differential features may be learned in one or both of the DoG and the Gaussian scale spaces to characterize local interest points from the reference image and the identified corresponding points in the remaining images of the group of images 202.

A ranking model training component 212 trains a ranking model based on the stability scores and extracted local differential features for later use in online processing.

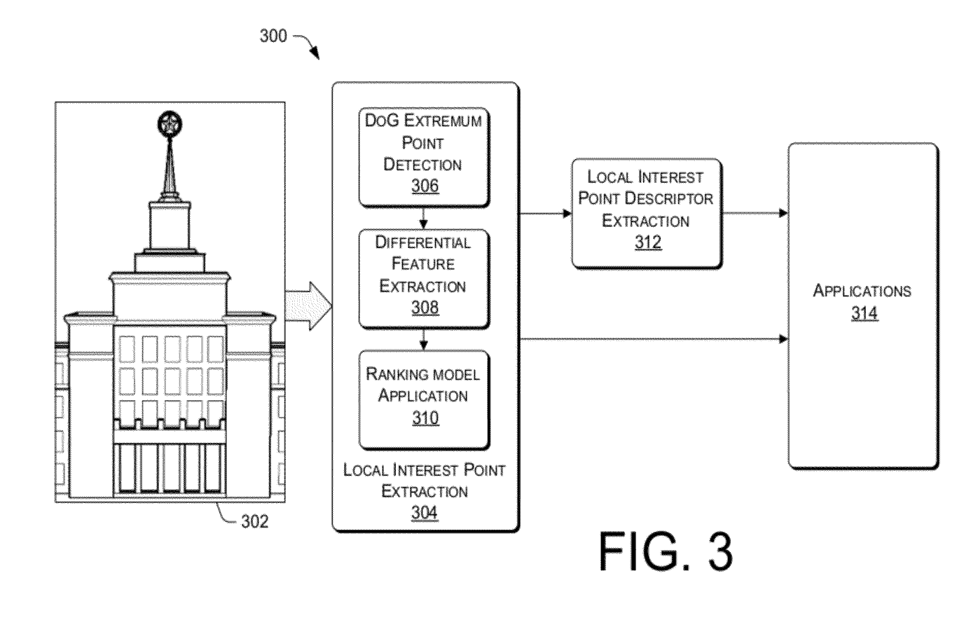

FIG. 3 is a block diagram of an example online framework 300 for ranking local interest points to improve local interest point detection according to some implementations. FIG. 3 illustrates that interest points learned from an image 302 may be used in any of multiple applications. According to framework 300, local interest point extraction component 304 performs operations to extract local interest points from image 302.

In the example illustrated, local interest point extraction component 304 includes a DoG Extremum point detection component 306. In some instances DoG Extremum point detection component 208 operates as DoG Extremum point detection component 306, while in other instances DoG Extremum point detection component 306 is an online component separate from DoG Extremum point detection component 208.

In the example illustrated, local interest point extraction component 304 also includes a differential feature extraction component 308. In some instances differential feature extraction component 210 operates as differential feature extraction component 308, while in other instances differential feature extraction component 308 is an online component separate from differential feature extraction component 210.

In addition, in the example illustrated, local interest point extraction component 304 also includes a ranking model application component 310 for sorting the DoG extremum points. In various implementations the ranking model application component 310 applies the ranking model trained as illustrated at 212.

The ranked interest points are output from local interest point extraction component 304 to supports applications 314. In various implementations, alternately or in addition, the ranked interest points that are output from local interest point extraction component 204 are used by local interest point descriptor extraction component 312, which extracts descriptors from the image patch around the interest points extracted to support applications 314 Rank-SIFT employs a supervised approach to learn a detector. The learned detector is scalable and parameter-free in comparison with rule-based detectors.

In the example shown in FIG. 3, ranking model application component 310 applies a ranking model to sort local points according to an estimation to their relative stabilities. Rather than binary classification (e.g., classifying a point as stable vs. unstable), the stability measure employed by ranking model application component 310 is relative but not absolute.

An output of a predetermined top number of local interest point descriptors extracted by component 312 may include, for example, stable image features and directional gradient information. Applications 314 may include for example, the afore mentioned computer vision applications such as object retrieval, object recognition, object categorization, panoramic image stitching, robotic mapping, robotic navigation, 3-D modeling, and determining structure from an object in motion including gesture recognition, video tracking, etc.

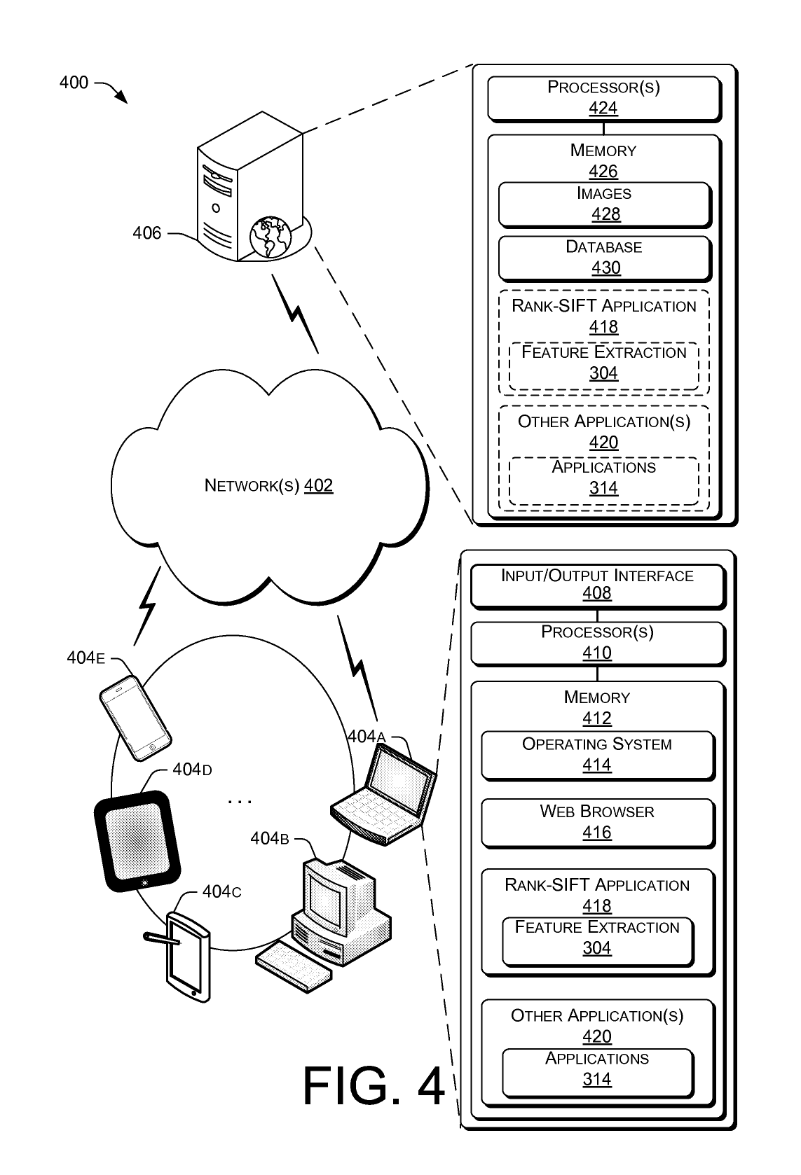

FIG. 4 illustrates an example computing architecture 400 in which techniques for learning to rank local interest points using Rank-SIFT may be implemented. The architecture 400 includes a network 402 over which a client computing device 404 may be connected to a server 406. The architecture 400 may include a variety of computing devices 404, and in some implementations may operate as a peer-to-peer rather than a client-server type network.

As illustrated, computing device 404 includes an input/output interface 408 coupled to one or more processors 410 and memory 412, which can store an operating system 414 and one or more applications including a web browser application 416, a Rank-SIFT application 418, and other applications 420 for execution by processors 410. In various implementations Rank-SIFT application 418 includes feature extraction component 304 while other applications 420 include one or more of applications 314.

In the illustrated example, server 406 includes one or more processors 424 and memory 426, which may store one or more images 428, and one or more databases 430, and one or more other instances of programming For example, in some implementations Rank-SIFT application 418, feature extraction component 304, and/or other applications 420 which may include one or more of applications 314, are embodied in server 406. Similarly, in various implementations one or more images 428, one or more databases 430 may be embodied in computing device 404.

While FIG. 4 illustrates computing device 404a as a laptop-style personal computer, other implementations may employ a desktop personal computer 404b, a personal digital assistant (PDA) 404c, a thin client 404d, a mobile telephone 404e, a portable music player, a game-type console (such as Microsoft Corporation's Xbox™ game console), a television with an integrated set-top box 404f or a separate set-top box, or any other sort of suitable computing device or architecture.

Memory 412, meanwhile, may include computer-readable storage media. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device such as computing device 404 or server 406.

In contrast, communication media may embody computer readable instructions, data structures, program modules, or other data in a modulated data signal, such as a carrier wave, or other transmission mechanism. As defined herein, computer storage media does not include communication media.

Rank-SIFT application 418 represents a desktop application or other application having logic processing on computing device 404. Other applications 420 may represent desktop applications, web applications provided over a network 402, and/or any other type of application capable of running on computing device 404. Network 402, meanwhile, is representative of any one or combination of multiple different types of networks, interconnected with each other and functioning as a single large network (e.g., the Internet or an intranet). Network 402 may include wire-based networks (e.g., cable) and wireless networks (e.g., Wi-Fi, cellular, satellite, etc.). In several implementations Rank-SIFT application 418 operates on client device 404 from a web page.

### Example Applications

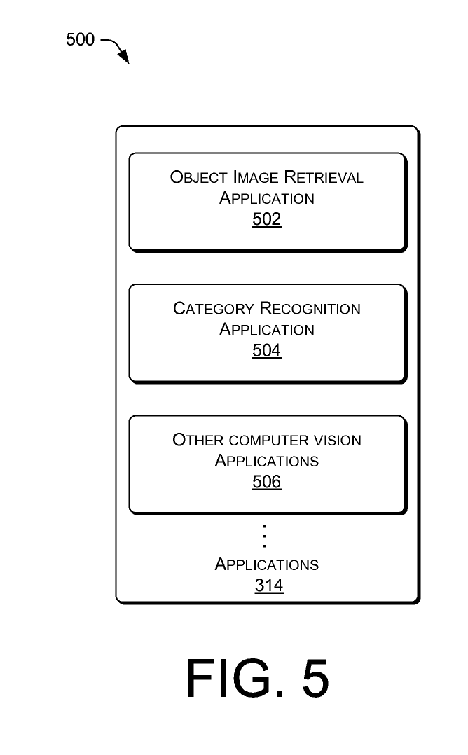

FIG. 5, at 500, illustrates some example applications 314 that can employ Rank-SIFT. Object image retrieval application 502 and category recognition application 504 are illustrated, although any number of other computer vision applications 506, or other applications may make use of Rank-SIFT including object categorization, panoramic image stitching, robotic mapping, robotic navigation, 3-D modeling, and determining structure from an object in motion including gesture recognition, video tracking, etc.

In several implementations a processor 410 is configured to apply Rank-SIFT to a group of images to obtain at least one region of interest for applications 314. Rank-SIFT tests and ranks the local interest points from the region of interest to identify stable local interest points. In turn, the stable local interest points are compared to scale invariant features of a training image including known objects to determine object(s) signified by the region of interest.

Applications, such as 502, 504, and 506, use identified local interest points in a variety of ways. For example, object image retrieval application 502 finds images with the same visual object as a query image. As another example, category recognition application 504 identifies an object category of a query image. In these and other such applications, Rank-SIFT provides for stability detection under varying imaging conditions including at least five different geometric and photometric changes (rotation, zoom, rotation and zoom, viewpoint, and light), also known as rotation and scale, compression, viewpoint, blur, and illumination.

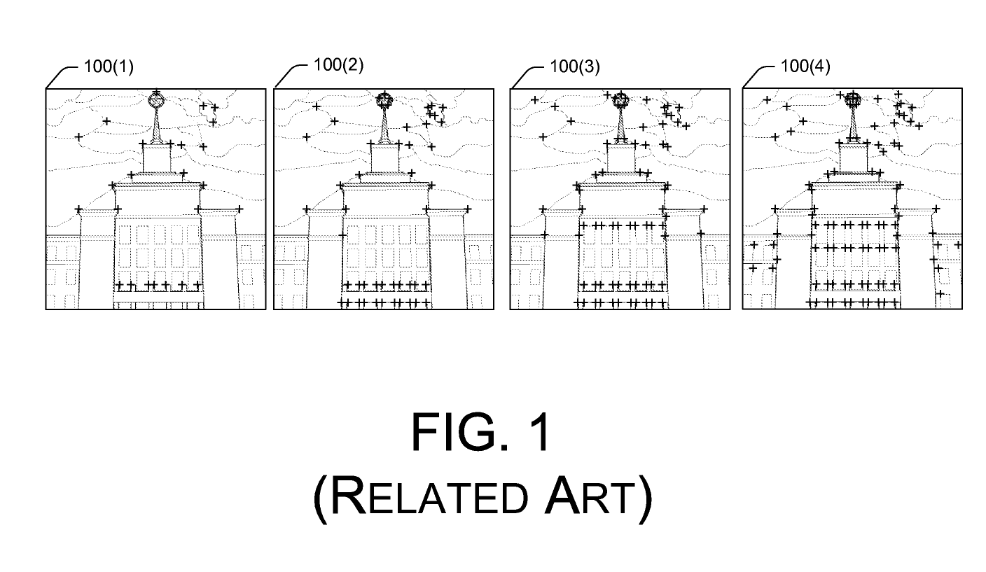

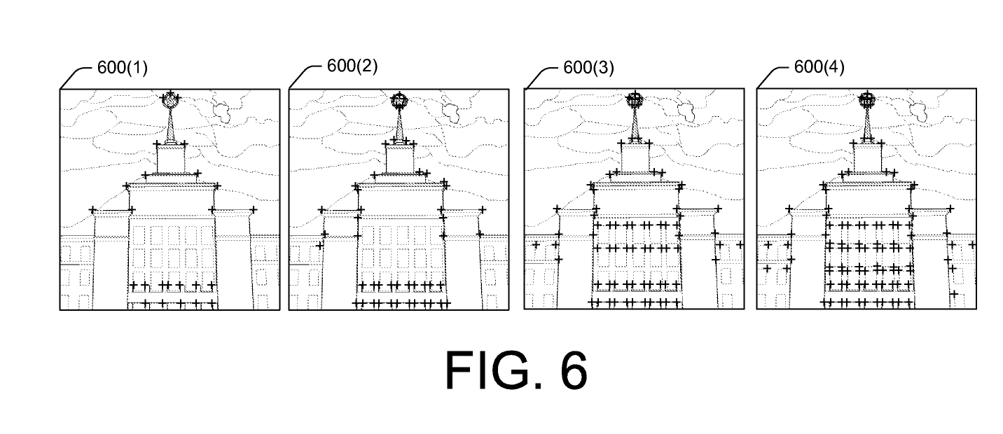

FIG. 6 is a set of four example images showing Rank-SIFT detection results according to some implementations. As illustrated, each “+” represents a local feature extracted by Rank-SIFT. In comparison to the sample output images of conventional SIFT using the same image as shown in FIG. 1, Rank-SIFT omits unstable local interest points from the sky or background.

For illustration and comparison to FIG. 1, the top 25 interest points are shown on image 600(1), 50 on image 600(2), 75 on image 600(3), and 100 on image 600(4). Note that for each image in FIG. 6, interest points are much more prevalent on the main object, the building of interest, compared to the points identified in FIG. 1.

FIGS. 1 and 6, discussed above, illustrate respective examples of interest points detected by the conventional SIFT and Rank-SIFT approaches. As shown in FIG. 1, noise points (in the sky or background) appear in the results of the SIFT detectors, while more accurate interest points are retrieved by the Rank-SIFT detector as illustrated in FIG. 6 due to such noise points being omitted from the results of the Rank-SIFT detector.

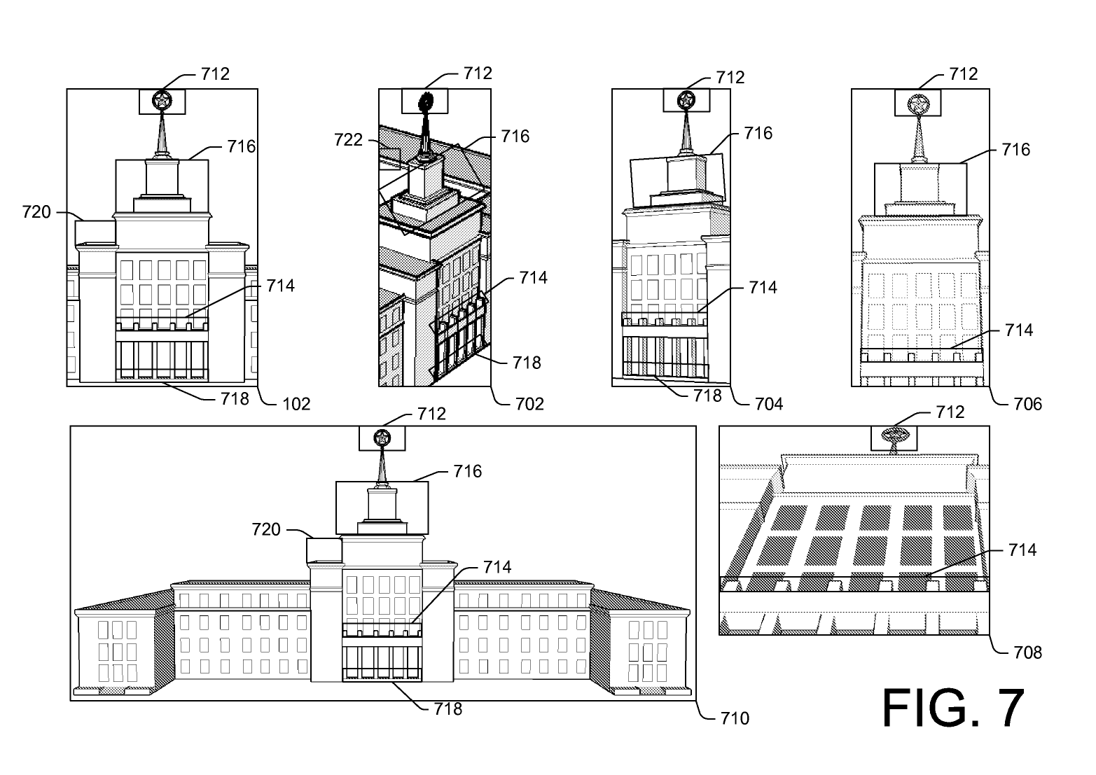

FIG. 7 is an image sequence of six images showing repeatability using Rank-SIFT according to some implementations. Detecting common interest points in an image sequence for the same object is often useful, in applications including panorama image stitching, object image retrieval, object category recognition, robotic mapping, robotic navigation, 3-D modeling, and determining structure from an object in motion including gesture recognition, video tracking, etc.

Suppose an image sequence {Iₘ, m=0, 1, . . . , M} contains the same visual object but with a gradual geometric or photometric transformation. Let image I₀ be the reference image, and Hₘ be the homography transformation from I₀ to Iₘ. The stability score of an interest point xᵢεI₀ can be therefore defined as the number of images which contains correctly matching point of xᵢ according to Equation 6.

R(xᵢεI₀)=ΘₘI(minₓ_{ⱼ}_{εI}_{ₘ}∥Hₘ(xᵢ)−xⱼ∥₂<ε) (6)

In Equation 6, I(.) is the indicator function and ∥.∥₂ denotes Euclidean distance. FIG. 7 demonstrates an example of calculating stability scores using Rank-SIFT. Rank-SIFT obtains the interest points with high R(xᵢεI₀) scores although other points with low R(xᵢεI₀) are also highlighted for illustration in FIG. 6 as discussed below.

FIG. 7 shows an image sequence of six images with different rotation and changes of scale. The image sequence includes images 302, 702, 704, 706, 708, and 710. Rectangles 712, 714, 716, 718, 720, and 722 have been placed on six matching regions to facilitate discussion.

Rank-SIFT ranks local DoG extremum points based on repeatability scores. For example, in the illustrated sequence, regions 712 and 714 are ranked highest relative to the other regions. That is local DoG extremum points in regions 712 and 714 have the highest R(xᵢεI₀) scores. However, local DoG extremum points in region 712 may be ranked highest overall due to local DoG extremum points within 714 not being visible in each of the images, for example due to the angle or rotation of image 708. In some instances local DoG extremum points may not repeat due to relative instability, although in the instance of a building, a local DoG extremum point not repeating is generally due to perturbations such as rotation, illumination, blur, etc. In the illustrated example, region 722 is ranked lowest, that is local DoG extremum points in region 722 have the lowest R(xᵢεI₀) scores due to the local DoG extremum points within 722 not being repeated in any of the images other than 702. Accordingly, using Equation 6, Rank-SIFT ranks particular local DoG extremum points in example regions 712, 714, 716, 718, 720, and 722 by their relative R(xᵢεI₀) scores.

Rank-SIFT uses a learning based approach to overcome problems from the conventional SIFT detector based on scale space theory.

Two scale spaces are used in conventional SIFT. The first is the Gaussian scale space (GSS), which corresponds to the multi-scale image representation, from which the second, the DoG space is derived. Meanwhile, the DoG space provides a close approximation to the scale-normalized Laplacian of Gaussian (LoG). According to properties of Laplacian operator, the value of each point in DoG space can be regarded as an approximation of twice the mean curvature.

In addition to the features D(\hat{x}) and Tr(H)²/Det(H) in the DoG space presented by conventional SIFT, Rank-SIFT employs the set of differential features illustrated in Table 1 in several implementations.

TABLE 1

| Feature | Feature Description |
|---|---|
| Derivative | Dx, Dy, Ds, Dxx, Dyy, Dss, Dxy, Dxs, Dys |
| Hessian | λ₁, λ₂, Det(H), Tr(H)²/Det(H) |
| Local Extremum | \|D(\hat{x})\|, δ\hat{x} = (δ\hat{x}, δŷ, δŝ)^{T} |

As shown in Table 1, Rank-SIFT first extracts the first and second derivative features from the DoG spaces. Based on these derivative features, Rank-SIFT extracts two additional sets of features. The first additional set are Hessian features, which include the eigenvalues (λ₁, λ₂), determinant Det(H), and the eigenvalue ratio trac(H)²/Det(H) of the Hessian matrix H in Eq. (4). The second additional set of features are extracted around the local DoG extremum, including the estimated DoG value |D(\hat{x})| defined in Equation (3) and the extremum shifting vector δ\hat{x} defined in Equation (2). Although the local extremum of DoG space provides stable image features, in some instances directional gradient information is lost. Directional gradient information is informative for identifying stable interest points. In order to address loss of directional gradient information, Rank-SIFT extracts the basic derivative features and Hessian features in the Gaussian scale space, which is shown in Table 2.

TABLE 2

| Feature | Feature Description |
|---|---|
| Basic | Dx, Dy, Ds, Dxx, Dyy, Dss, Dxy, Dxs, Dys |
| Hessian | λ₁, λ₂, Det(H), Tr(H)²/Det(H) |

In various implementations Rank-SIFT uses three sets of learning strategies to compare the efficiency of features in different spaces: 1) the DoG feature set, using all DoG features described in Table 1; 2) the GSS+DoG feature set, using both DoG features and Gaussian features described in Tables 1 and 2; and 3) the GSS feature set, using the Gaussian features by adding local extremum features described in the third row of Table 1.

Rank-SIFT builds on DoG extremum, by computing the DoG extremum and deciding which particular extremum is stable by computing a stability score for each extremum. In accordance with scale-space theory, in various implementations Rank-SIFT omits points that are not DoG extremum.

For learning to rank, Rank-SIFT employs the following model for ranking stable local interest points, although other models may be used in various implementations. Suppose xᵢ and xⱼ are two interest points in image I. Based on the definition in Equation (6), if R(xᵢεI)>R(xⱼεI), the point xᵢ is more stable than the point xⱼ, denoted as xⱼ<xᵢ. In this way, Rank-SIFT obtains interest points pairs <xⱼ<xᵢ>. Note that relationships between points with the same stability scores or from different images are undefined when using Rank-SIFT in some implementations. Assuming that f(x)=w^{T}x is a linear function, according to Rank-SIFT, it meets the conditions set forth in Equation 7.

xⱼ<xᵢ [symbol] f(xᵢ)>f(xⱼ) (7)

Therefore, a constraint defined on a pair of interest points is converted to

w^{T}xᵢ−w^{T}xⱼ≧1 [symbol] w^{T}(xᵢ−xⱼ)≧1

The term w^{T}(xᵢ−xⱼ)≧1 is a constraint of a support vector machine (SVM) classifier, in which Rank-SIFT regards the difference xᵢ−xⱼ as a feature vector.

### Example Process

A training set can be constructed for Rank-SIFT by counting the frequencies of DoG extremum appearing in an image sequence. The features for each point are extracted, and for example, three pixels may be chosen as the minimal distance to judge repeatability (ε=3 in Equation (6)). Moreover, a point in an image may be restricted to only correspond to one point in another image. In one example implementation, 125,361 points were used for training, although other values may be used without limitation. Details of an example training set are listed in Table 3.

TABLE 3

Rank

| | 5+ | 4 | 3 | 2 | 1 | 0 |
|---|---|---|---|---|---|---|
| Percentage (%) | 25.6 | 3.9 | 6.5 | 12.5 | 22.6 | 28.9 |

Three configurations of the GSS and DoG features can be used in the Rank-SIFT framework. In at least one implementation Rank-SIFT uses a ranking support vector machine (SVM) with a linear kernel to train the ranking model. In one example implementation, three models were trained based on three feature configurations, i.e. GSS, DoG, and GSS+DoG, while a conventional SIFT detector was chosen to represent a baseline.

Repeatability and matching score are used as measures to evaluate the stability of different detectors according to some implementations. Both of the two measures are defined on an image pair <A,B> as shown below,

$$Repeatability ( A , B ) = \frac{\# Repeat ( A , B )}{min ( A , B )}$$

$$MatchingScore ( A , B ) = \frac{\# Repeat ( A , B ) ⋂ ClearMatch ( A , B )}{min ( A , B )}$$

where Repeat(A, B) means the set of repeated interest points in the two images, ClearMatch(A, B) means the set of points which are a “clear match” in the image pair, and min(A, B) means the minimum number of points in A and B. When two interest points from two images respectively are the nearest neighbor to each other, they are judged as a “clear match.” In one example implementation Euclidean distance (L2) and SIFT descriptors are used to measure the distance between points.

In one example implementation, six different parameter configurations for the conventional SIFT algorithm and Rank-SIFT were evaluated, as listed in Table 4.

TABLE 4

Parameters

| | p₁ | P₂ | P₃ | P₄ | P₅ | P₆ |
|---|---|---|---|---|---|---|
| γ₁ | 0.03 | 0.03 | 0.03 | 0.03 | 0 | 0 |
| γ₂ | 2 | 4 | 5 | 10 | 8 | 10 |

Since the repeatability and matching score depend on the number of points being detected, in the example implementation, the same number of interest points are used for Rank-SIFT as those obtained by the conventional SIFT detector. To leverage Rank-SIFT, in particular, the top ranked interest points obtained by Rank-SIFT methods are used. For each image sequence, the first image is deemed a reference image, and other images in conjunction with the reference image are used to construct image pairs. The repeatability and matching score measures are computed based on these image pairs. To determine the overall performance for a sequence (e.g., for a kind of geometric or photometric transformation), an average score over image pairs of the sequence is calculated.

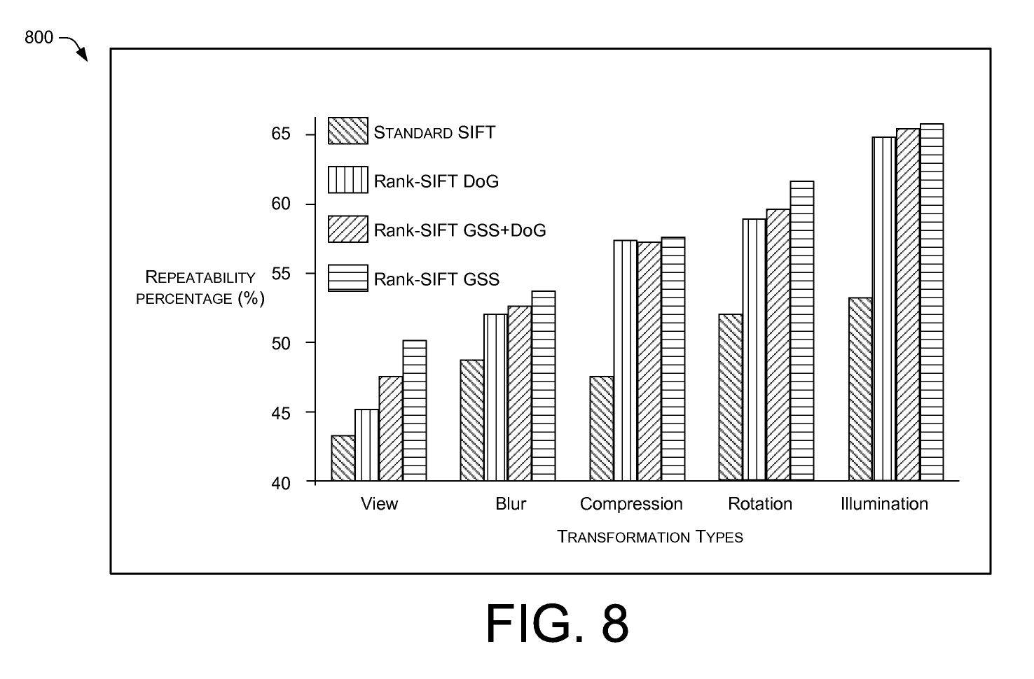

FIG. 8 at 800 shows average repeatability of the conventional SIFT, Rank-SIFT DoG, Rank-SIFT GSS+DoG, and Rank-SIFT GSS detectors from one example implementation. As illustrated, Rank-SIFT outperforms conventional SIFT with respect to imaging conditions including view, blur, compression, rotation, and illumination, while GSS achieves the best results in the three Rank-SIFT feature configurations. As illustrated in FIG. 8, the repeatability percentage increases moving from left to right from “view” to “illumination.” This provides an indication of relative perturbations from different geometry and photometric changes, with viewpoint change being the most difficult change to accommodate.

Rank-SIFT illustrates that GSS features are more robust than DoG features in terms of detecting stable interest points. While a single feature GSS outperforms a combined feature GSS+DoG in the illustrated example 800, this phenomenon is likely to be caused by over-fitting. The training and test images were collected by different people at different times with different devices. Thus, local features of the training and test images generated for the illustrated example may not have been independent and identically distributed (i.i.d.). Since DoG features are higher order differentials than GSS feature, the DoG features are more sensitive to noise in images than the GSS features.

Using the six-parameter configurations from table 4, a comparison of Rank-SIFT, using the model based on the GSS features and using the same number of top-ranking-score interest points, with the SIFT detector is shown by retrieval accuracy mean average precision (mAP) for an example implementation run on the Oxford building database in Table 5.

TABLE 5

| | Parameters | | | | | |
|---|---|---|---|---|---|---|
| | p₁ | P₂ | P₃ | P₄ | P₅ | P₆ |
| Conv. SIFT | 0.424 | 0.541 | 0.583 | 0.605 | 0.603 | 0.610 |
| Rank-SIFT | 0.449 | 0.576 | 0.661 | 0.633 | 0.664 | 0.664 |

The Oxford building database contains 5063 images with 55 queries of 11 Oxford landmarks.

Given a query image and an image in the database, three steps are conducted to compute their similarity: 1) compute a list of clear matched interest points; 2) estimate a transformation matrix between the two images; and 3) count the number of interest points that are matched in the two images according to the transformation matrix. Due to the heavy computational cost in the second step, the transformation matrix may be estimated by the random sample consensus (RANSAC) algorithm and called a homography in some implementations. The ranking for all images in the database is based on their numbers of interest points matched with the query image. Average precision score is computed to measure the retrieval results for each query. The average precision score is defined as the area under the precision-recall curve for each query, and a mean Average Precision (mAP) of all the 55 queries is computed. As shown in Table 5, a detector having a higher matching score achieves a higher mAP value.

Another application of Rank-SIFT is object category recognition. The goal of object category recognition is to train a classifier to recognize objects in the test images. For example, Rank-SIFT was applied to the PASCAL Visual Object Classes 2006 dataset, which contains 2618 training and 2686 test images in 10 object categories, e.g. cars, animals, persons, etc. To bypass effects of complex algorithms and parameter settings, in one example implementation a basic method was adopted to perform the classification task. The example basic method includes the following steps: 1) detecting a set of local interest points with descriptors first for each image; 2) constructing a dictionary by clustering local interest features into groups; 3) quantizing local descriptors by the dictionary to obtain histogram-based features for images; and 4) training a SVM classifier with a histogram intersection kernel.

Following the example settings discussed above regarding Tables 4 and 5, six parameter configurations (p₁˜p₆) of the SIFT algorithm were evaluated. For each example configuration, the same number of interest points were used for both SIFT and Rank-SIFT. The dictionary was separately constructed for each configuration, as the detected local interest points changed under different configurations. The dictionary size was chosen as 200, and k-means was adopted to generate the dictionary in one implementation. The comparison results are shown in Table 6, from which it is clear that Rank-SIFT significantly outperforms the SIFT detector on recognition accuracy.

TABLE 6

| | Parameters | | | | | |
|---|---|---|---|---|---|---|
| | p₁ | P₂ | P₃ | P₄ | P₅ | P₆ |
| Conv. SIFT | 44.7 | 45.5 | 46.7 | 46.8 | 49.3 | 49.4 |
| Rank-SIFT | 46.7 | 50.1 | 51.6 | 50.2 | 50.4 | 50.8 |

### Example Process

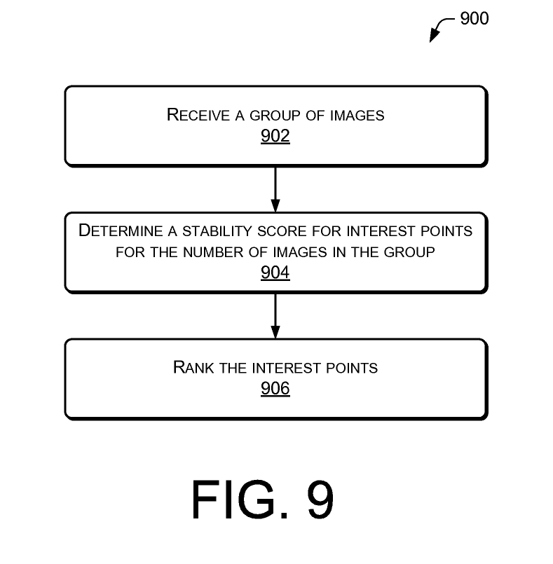

FIGS. 9-11 are flow diagrams of example processes 900, 1000, and 1100, respectively, for example processes for learning to rank local interest points using Rank-SIFT consistent with FIGS. 2-8.

In the flow diagrams of FIGS. 9-11, the processes are illustrated as collections of acts in a logical flow graph, which represents a sequence of operations that can be implemented in hardware, software, or a combination thereof. In the context of software, the blocks represent computer-executable instructions that, when executed by one or more processors, program a computing device 404 and/or 406 to perform the recited operations. Generally, computer-executable instructions include routines, programs, objects, components, data structures, and the like that perform particular functions or implement particular abstract data types. Note that order in which the blocks are described is not intended to be construed as a limitation, and any number of the described operations can be combined in any order and/or in parallel to implement the process, or an alternate process. Additionally, individual blocks may be deleted from the process without departing from the spirit and scope of the subject matter described herein. In various implementations one or more acts of processes 900, 1000, and 1100 may be replaced by acts from the other processes described herein. For discussion purposes, the processes 900, 1000, and 1100 are described with reference to the frameworks 200 and 300 of FIGS. 2 and 3 and the architecture of FIG. 4, although other frameworks, devices, systems and environments may implement this process.

FIG. 9 presents process 900 of determining a stability score for training to rank local interest points using Rank-SIFT, according to Rank-SIFT application 418, for example. At 902, Rank-SIFT application 418 receives or otherwise obtains a group of images 202 at computing device 404 or 406 for use in an application 314 such as a computer vision application as discussed above.

At 904, Rank-SIFT application 418 determines a stability score for interest points of the received images according to the number of images in the group of images received at 902.

At 906, Rank-SIFT application 418 ranks the interest points according to their relative stability scores.

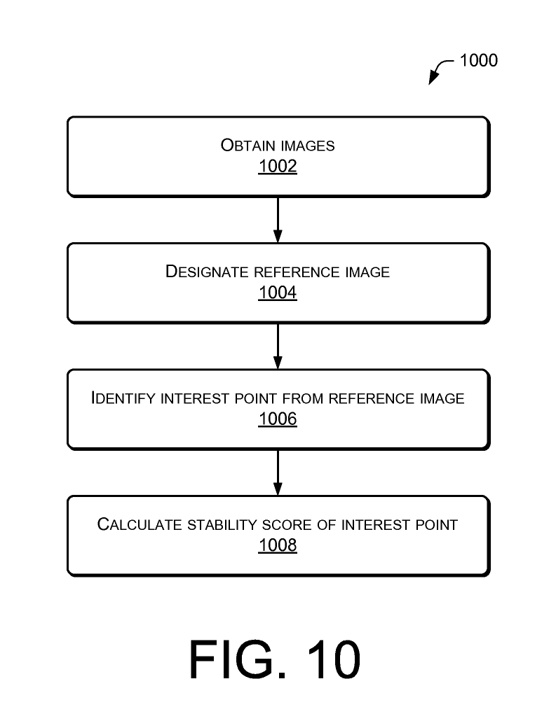

FIG. 10 presents process 1000 of calculating a stability score for a local interest point from a group of images with the same visual object to rank local interest points using Rank-SIFT, according to Rank-SIFT application 418, for example. At 1002, Rank-SIFT application 418 receives or otherwise obtains a group or sequence of images 202 at computing device 404 or 406 for use in an application 314 such as a computer vision application as discussed above. For example, the group or sequence of images 202 may contain the same object with geometric and/or photometric transformation.

At 1004, Rank-SIFT application 418 designates a particular image of the images received at 1002 as a reference image.

At 1006, Rank-SIFT application 418 identifies an interest point from the reference image.

At 1008, Rank-SIFT application 418 calculates a stability score of the interest point from the reference image. In various implementations the stability score is based on the number of images in the group containing points identified as matching the interest point as defined according to Equation 6.

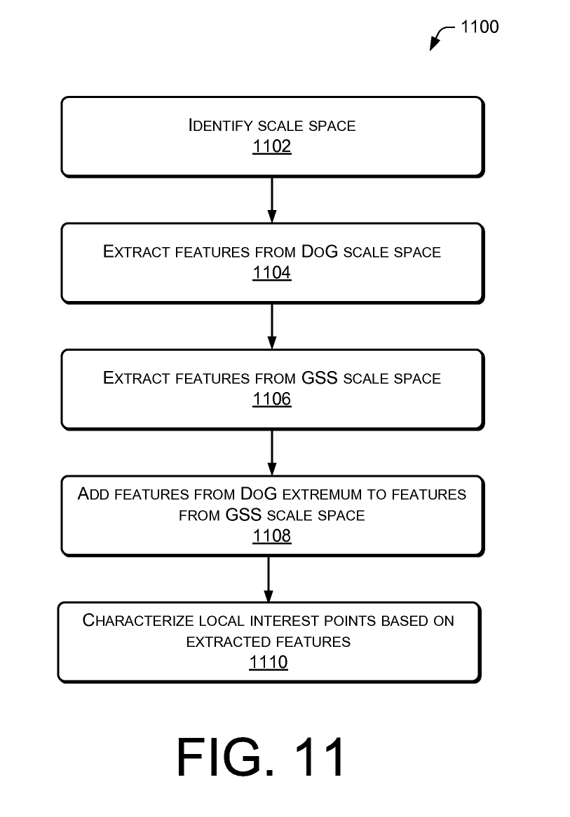

FIG. 11 presents process 1100 of calculating a ranking score using the model learned from offline training to rank local interest points using Rank-SIFT, according to Rank-SIFT application 418, for example. At 1102, Rank-SIFT application 418 identifies a scale space including the GSS and DoG scale spaces for a group of images.

At 1104, Rank-SIFT application 418, for the DoG scale space, extracts sets of first and second derivative features, a set of Hessian features, and a set of features around local DoG extremum.

At 1106, Rank-SIFT application 418, for the GSS scale space, extracts sets of first and second derivative features and a set of Hessian features.

At 1108, in some implementations, Rank-SIFT application 418, for the GSS scale space, adds the set of features around local DoG extremum from 1104 to 1106.

At 1110, Rank-SIFT application 418, characterizes local interest points to obtain local differential features based on the extracted features.

### CONCLUSION

The above framework and process for learning to rank local interest points using Rank-SIFT may be implemented in a number of different environments and situations. While several examples are described herein for explanation purposes, the disclosure is not limited to the specific examples, and can be extended to additional devices, environments, and applications.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

We claim:

1. A method comprising:
receiving a group of images;
calculate and build a Gaussian scale space (GSS) for each image of the group of images;
identifying a local extremum point as a local interest point candidate in a difference of Gaussian (DoG) scale space;
extracting features from the GSS; and
characterizing local interest points based at least on the features extracted from the GSS.

2. A method as recited in claim 1, wherein at least one image of the group of images represents at least one of a geometric change or a photometric change of another image of the group of images.

3. A method as recited in claim 2, wherein the at least one of the geometric change or the photometric change includes at least one of view, rotation, illumination, blur, or compression.

4. A method as recited in claim 1, the features extracted from the GSS including at least first and second derivative features.

5. A method as recited in claim 1, the features extracted from the GSS including at least Hessian features.

6. A method as recited in claim 1, further comprising providing at least some of the local interest points to a computer vision application.

7. A method as recited in claim 1, further comprising, for pairs of images from the group of images, calculating a stability score for the local interest points.

8. A method as recited in claim 1, further comprising ranking the local interest points.

9. A method as recited in claim 1, further comprising training a ranking model based at least on the candidate local point identified as the stable point in the DoG scale space and local differential features for the candidate local point.

10. A method as recited in claim 9, the features extracted from the DoG scale space including at least first and second derivative features.

11. A method as recited in claim 9, the features extracted from the DoG scale space including at least Hessian features.

12. A method as recited in claim 9, the features extracted from the DoG scale space including at least features around local DoG extremum points.

13. A method as recited in claim 12, further comprising:
adding the features around local DoG extremum points extracted to the features extracted from the GSS; and
the characterizing local interest points further being based at least on the features around local DoG extremum points extracted.

14. A computer-readable medium having computer-executable instructions recorded thereon, the computer-executable instructions to configure a computer to perform operations comprising:
obtaining a group of images;
designating a selected image of the group of images as a reference image;
determining a DoG extremum point in the reference image;
calculating a stability score of the DoG extremum point in the reference image and at least one other image of the group of images based at least on a homography transformation matrix; and
ranking the DoG extremum point based at least on the stability score to obtain a local interest point for the group of images.

15. A computer-readable medium as recited in claim 14, wherein the stability score is based at least on a number of images in the group of images containing interest points matching at least one interest point in the reference image.

16. A computer-readable medium as recited in claim 14, wherein at least one image of the group of images represents at least one of a geometric change or a photometric change of another image of the group of images.

17. A computer-readable medium as recited in claim 16, wherein the at least one of the geometric change or the photometric change includes at least one of view, rotation, illumination, blur, or compression.

18. A computer-readable medium as recited in claim 14, the stability score being calculated based at least on features extracted from the GSS including at least one of first derivative features, second derivative features, or Hessian features.

19. A system comprising:
a processor;
a memory coupled to the processor, the memory storing components for learning to rank local interest points, the components including:
an interest point detection component to identify stable local points in a group of images;
a differential feature extraction component configured to employ a supervised learning model to learn differential features; and
a ranking model training component to train a ranking model to sort the local interest points based at least in part on relative stabilities of the local interest points.

20. A system as recited in claim 19, wherein the interest point detection component identifies DoG extremum points.
